(19) United States
(12) Patent Application Publication
(10) Pub. No.: US 2015/0260607 A1
(43) Pub. Date: Sep. 17, 2015

(54) FLUID PROBE WITH FIBER BRAGG GRATING SENSOR

(71) Applicant: General Electric Company, Schenectady, NY (US)

(72) Inventors: Fredrick Levi Fuller, Schenectady, NY (US); Michael Richard Pomykai, Scotia, NY (US); Zachary John Snider, Simpsonville, SC (US); Hua Xia, Huffman, TX (US); Bernard Zabek, Clifton Park, NY (US)

(73) Assignee: General Electric Company, Schenectady, NY (US)

(21) Appl. No.: 14/215,599

(22) Filed: Mar. 17, 2014

(51) Int. Cl. G01M 11/00; G01M 15/14; G02B 6/34

(52) U.S. Cl. CPC G01M 11/31; G02B 6/34; G01M 15/14

(57) ABSTRACT

Aspects of the present disclosure related generally to a fluid probe with one or more Fiber Bragg Grating (FBG) sensors. An apparatus according to the present disclosure can include a fluid probe configured to be positioned within a fluid flow section of a turbomachine; and a Fiber Bragg Grating (FBG) sensor coupled to the fluid probe and configured to indicate a material property at a particular location on the fluid probe.

### BACKGROUND OF THE INVENTION

The subject matter disclosed herein relates to monitoring material properties at particular locations on a fluid probe. More specifically, the present disclosure relates to fluid probes which include at least one Fiber Bragg Grating (FBG) sensor.

In turbomachines, such as steam turbines, the properties of an operating fluid may substantially affect the performance characteristics (e.g., efficiency) of a turbomachine assembly. Many turbomachines include several stages which extract energy from successively lower-pressure operating fluids. In a low pressure stage of a turbomachine, even minor changes in an operating fluid's pressure, temperature, and/or fluid velocity can cause high percentage changes to the turbomachine's performance. Fluid probes designed to measure a particular property (e.g., temperature or pressure) of an operating fluid can read these aspects of the turbomachine's performance.

Fluid probes are reliable measuring instruments, but may experience wear after extended use. To monitor the health of a fluid probe, some measurement instruments can measure the fluid probe's condition, including material strain or other characteristics. However, these instruments may be difficult to install or may affect the fluid probe's performance. In addition, adding these measurement instruments to a fluid probe may change the fluid probe's mass and exterior contour.

### BRIEF DESCRIPTION OF THE INVENTION

At least one embodiment of the present disclosure is described herein with reference to fluid probes with one or more Fiber Bragg Grating (FBG) sensors. However, it should be apparent to those skilled in the art and guided by the teachings herein that embodiments of the present invention are applicable to monitoring the performance and health of other structures by measuring various physical quantities.

A first aspect of the present disclosure provides an apparatus. The apparatus can include a fluid probe configured to be positioned within a fluid flow section of a turbomachine; and a Fiber Bragg Grating (FBG) sensor coupled to the fluid probe and configured to indicate a material property at a particular location on the fluid probe.

A second aspect of the present disclosure provides an apparatus. The apparatus can include a fluid probe configured to be positioned within a fluid flow section of a turbomachine; and a Fiber Bragg Grating (FBG) sensor positioned within, e.g., an interior cavity of the fluid probe such that a clearance region exists between the FBG sensor and a sidewall of the interior cavity, wherein the FBG sensor is configured to indicate a fluid condensation level within the interior cavity of the fluid probe.

A third aspect of the present disclosure provides an apparatus. The apparatus can include a fluid probe configured to be positioned within a fluid flow section of a turbomachine; and a Fiber Bragg Grating (FBG) sensor coupled to a sidewall of an interior cavity of the fluid probe, wherein the FBG sensor is configured to indicate a material strain on the fluid probe.

### BRIEF DESCRIPTION OF THE DRAWING

These and other features of the disclosed apparatuses will be more readily understood from the following detailed description of the various aspects of the apparatus taken in conjunction with the accompanying drawings that depict various embodiments of the invention, in which:

FIG. 1 is a perspective partial cut-away illustration of a steam turbine.

FIG. 2 is a cross sectional view of a fluid flow section of a turbomachine and a fluid probe according to an embodiment of the present disclosure.

FIG. 3 is a schematic of a fluid probe with a Fiber Bragg Grating sensor according to an embodiment of the present disclosure.

FIG. 4-5 each depict a cross-sectional view of a fluid probe and a Fiber Bragg Grating sensor according to embodiments of the present disclosure.

It is noted that the drawings are not necessarily to scale. The drawings are intended to depict only typical aspects of the disclosure, and therefore should not be considered as limiting its scope. In the drawings, like numbering represents like elements between the drawings.

### DETAILED DESCRIPTION OF THE INVENTION

In the following description, reference is made to the accompanying drawings that form a part thereof, and in which is shown by way of illustration specific exemplary embodiments in which the present teachings may be practiced. These embodiments are described in sufficient detail to enable those skilled in the art to practice the present teachings and it is to be understood that other embodiments may be used and that changes may be made without departing from the scope of the present teachings. The following description is, therefore, merely exemplary.

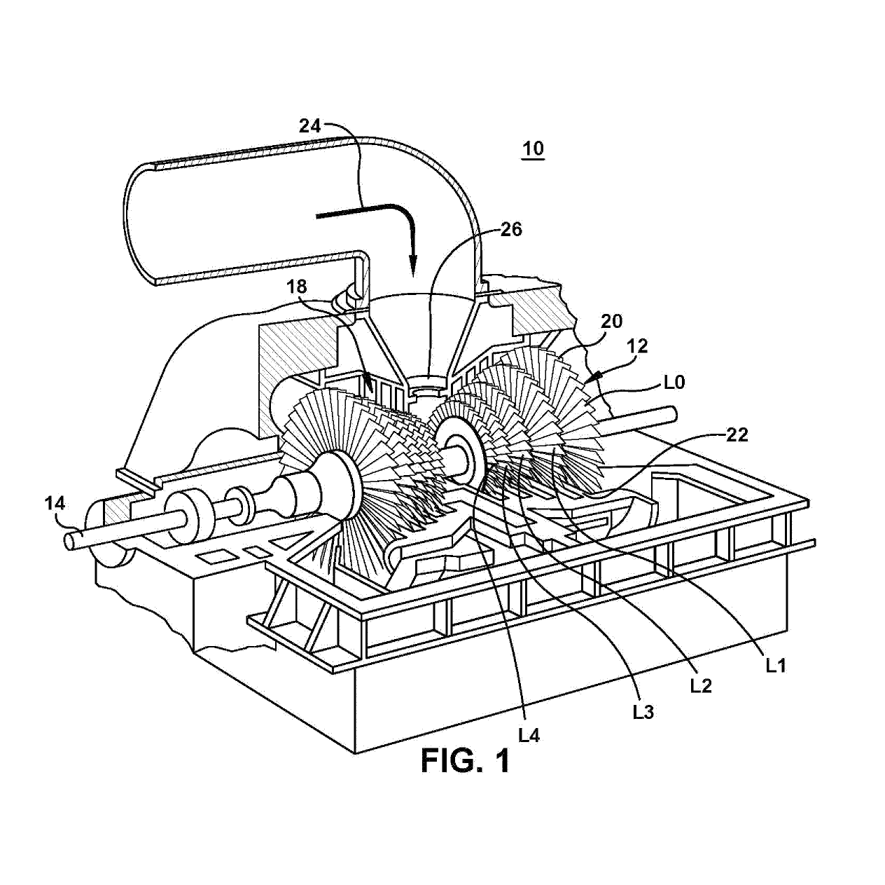

Embodiments of the present disclosure include an apparatus for installation and use in turbomachines, such as steam turbines and gas turbines. Referring to the drawings, FIG. 1 shows a perspective partial cut-away illustration of a steam turbine 10 included as an example of a turbomachine. Steam turbine 10 includes a rotor 12 that includes a shaft 14 and a plurality of axially spaced rotor wheels 18. A plurality of rotating blades 20 are mechanically coupled to each rotor wheel 18. More specifically, blades 20 are arranged in rows that extend circumferentially around each rotor wheel 18. A plurality of stationary vanes 22 extend circumferentially around shaft 14 and are axially positioned between adjacent rows of blades 20. Stationary vanes 22 cooperate with blades 20 to form a turbine stage and define a portion of a steam flow path through turbine 10.

In operation, steam 24 enters an inlet 26 of turbine 10 and is channeled through stationary vanes 22. Vanes 22 direct steam 24 downstream against blades 20. Steam 24 passes through the remaining stages imparting a force on blades 20 causing shaft 14 to rotate. At least one end of turbine 10 may extend axially away from rotor 12 and may be attached to a load or machinery (not shown) such as, but not limited to, a generator, and/or another turbine. Accordingly, a large steam turbine unit may actually include several turbines each co-axially coupled to the same shaft 14. Such a unit may, for example, include a high pressure section coupled to an intermediate-pressure section, which in turn is coupled to a low pressure section.

In one embodiment of the present invention and shown in FIG. 1, turbine 10 can comprise five stages referred to as L0, L1, L2, L3 and L4. Stage L4 is the first stage and is the smallest (in a radial direction) of the five stages. Stage L3 is the second stage and is the next stage in an axial direction. Stage L2 is the third stage and is shown in the middle of the five stages. Stage L1 is the fourth and next-to-last stage. Stage L0 is the last stage and is the largest (in a radial direction). It is to be understood that five stages are shown as one example only, and a section of a turbine (e.g., a low pressure section) can have more or less than five stages.

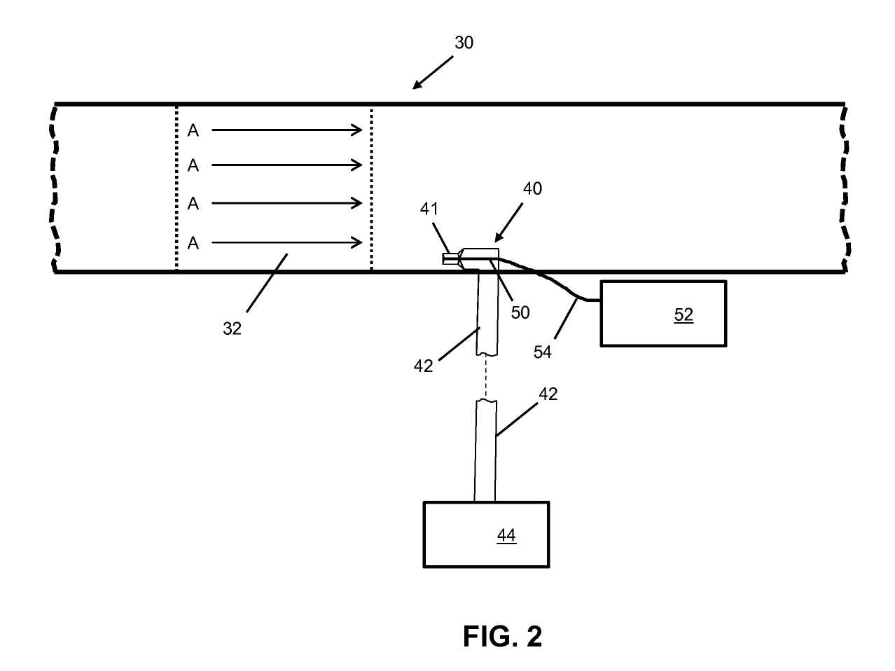

Turning to FIG. 2, an example fluid flow section 30 of a turbomachine (e.g., steam turbine 10, (FIG. 1)) is shown. Fluid flow section 30, e.g., can be within a low pressure section of a turbomachine, where small changes in an operating fluid's pressure, temperature, and/or other properties can yield high percentage changes in the low pressure section's efficiency. Operating fluid 32, which can be in the form of a gas such as steam or a liquid such as water, can flow through fluid flow section 30 substantially along the direction of arrows A. Operating fluid 32 within fluid flow section 30 may have particular values of pressure, temperature, fluid velocity, etc., and a user or operator may desire to know these particular properties of operating fluid 32 to analyze the turbomachine's performance. A fluid probe 40 can be positioned within fluid flow section 30 to monitor the pressure, temperature, fluid velocity, and/or other properties of operating fluid 32. In an embodiment, fluid probe 40 can include a kiel head pressure port 41 which may be oriented in a particular direction, e.g., directly opposed to the flow of operating fluid 32 along arrow A. Fluid probe 40 can have any desired length, e.g., several inches, several feet, etc., and is shown with a broken line to illustrate an indeterminate length. Fluid probe 40 can include a tube 42 for diverting a small amount of operating fluid 32 toward a pressure converter 44. Pressure converter 44 can include any currently known or later developed measuring tool, such as a manometer for measuring the pressure of operating fluid 32 as a numerical pressure value. In addition or alternatively, fluid probe 40 can be coupled to other types of measuring instruments (e.g., thermometers, optical sensors, etc.) for measuring other properties of operating fluid 32, such as temperature, fluid velocity, flow rate, etc.

Embodiments of the present disclosure can monitor the condition of tools, such as fluid probe 40, within a fluid flow section 30 of a turbomachine (e.g., steam turbine 10). Embodiments of the present disclosure can monitor, for example, the material strain of fluid probe 40 or the concentration of fluids within fluid probe 40. To monitor fluid probe 40, related properties (e.g., temperature or pressure) can be measured and encoded in the form of a signal. In some cases, a physical measurement can be encoded into an electrical signal or an optical signal. “Fiber optic cables” and related fiber optic tools can send, transmit, and/or receive optical signals. To form a fiber optic cable, certain types of fiber and glass can be machined into a cable-type structure for transmitting light.

One type of fiber optic tool is a “Fiber Bragg Grating” (FBG) sensor. Generally, an FBG sensor refers to a particular portion of a fiber optic cable which is machined, processed, etc., to have a different index of refraction than the remainder of the fiber optic cable. Generally, a fiber optic cable can be composed of a transparent material through which substantially any wavelength of an optical signal can pass. Changing the refractive index of a transparent material, however, can render the material “translucent.” In a translucent material, some wavelengths of light can pass through the material, while other wavelengths are diverted (“diffracted”) or blocked entirely. The refractive index of a particular sensor can determine which wavelengths will pass through the FBG sensor and which wavelengths will be rejected. One type of FBG sensor is a “bandpass” sensor, where only predetermined wavelengths of light can pass through the translucent sensor while all others are rejected (i.e., diffracted or reflected). Another type of FBG sensor is a “band reject” sensor, where only a predetermined range of wavelengths are rejected (i.e., diffracted or reflected) by the band reject FBG sensor, while all others can pass through the FBG sensor. The present disclosure generally describes the use of “band reject” FBG sensors by way of example only, and it is understood that the same principles described herein may also apply with “bandpass” FBG sensors.

To monitor the condition of fluid probe 40, at least one FBG sensor 50 can be coupled to fluid probe 40. FBG sensor 50 can monitor material properties, e.g., material strain on and/or fluid condensation within fluid probe 40, which can be derived from temperature changes, thermal expansion or contraction, and/or other material changes which affect both fluid probe 40 and FBG sensor 50. One or more FBG sensors 50 can be coupled to fluid probe 40 by any means currently known or later developed, such as being bonded or mechanically coupled to fluid probe 40. FBG sensor 50 can be coupled to fluid probe 40 at any desired exterior or interior location. The exterior shape of fluid probe 40, however, can affect the efficiency of operating fluid 32 passing through fluid flow section 30. Positioning FBG sensor 50 inside of fluid probe 40 can avoid changes to the exterior contour of fluid probe 40. FBG sensors 50 positioned inside of fluid probe 40 can be located within an interior cavity of fluid probe 40, as discussed in further detail elsewhere herein. FBG sensor 50 can be coupled to an optical interrogator system 52 through an optical coupling 54. Optical coupling 54 can be in the form of, e.g., an extension to the fiber optic material or cable used in FBG sensor 50, or any other component capable of transmitting an optical signal.

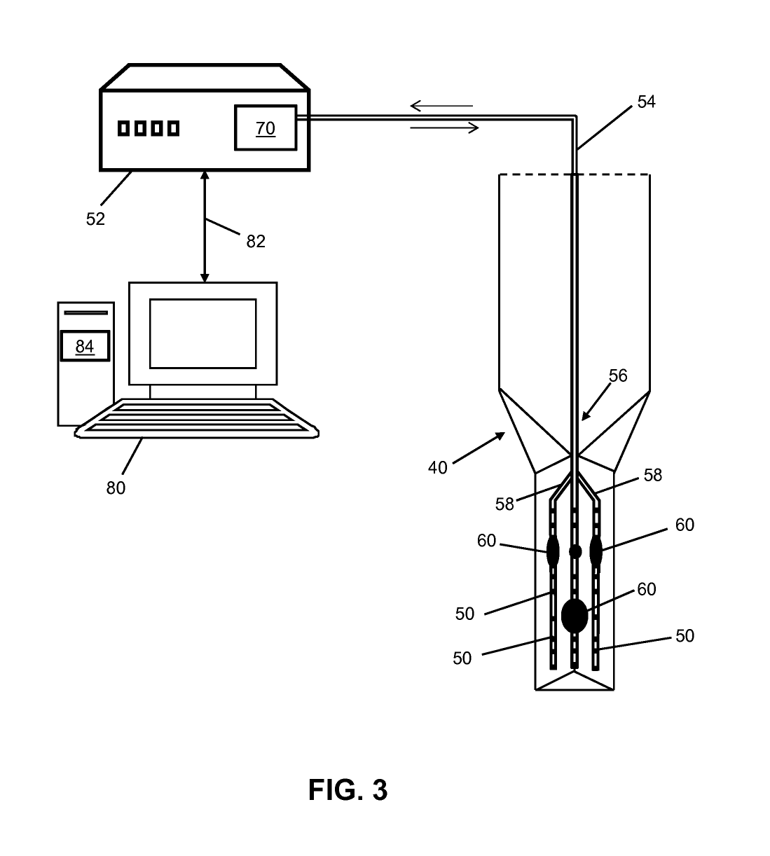

Turning to FIG. 3, a system including fluid probe 40 and optical interrogator system 52 is shown. Although embodiments of the present disclosure contemplate at least one FBG sensor 50 being coupled to fluid probe 40, a plurality of FBG sensors 50 can be included in an embodiment of the disclosure. Each one of the plurality of FBG sensors 50 can indicate the condition of fluid probe 40 at their corresponding locations. Thus, a plurality of FBG sensors 50 together can measure the material properties of different locations on fluid probe 40. Each one of the plurality of FBG sensors 50 can be spaced apart from each other at any desired interval. For example, ten FBG sensors 50 can be positioned along a fiber optic cable, and may be spaced, e.g., between approximately twenty and thirty millimeters apart from each other. The number of FBG sensors 50 and the spacing between them can be modified to accommodate different types of fluid probes 40. For example, embodiments of the present disclosure can include hundreds of FBG sensors 50 spaced evenly or unevenly throughout one or more fiber optic cables. Furthermore, FBG sensors 50 can be concentrated more closely together in locations of fluid probe 40 where changes in the condition of fluid probe 40 are more likely to have a significant effect.

To transmit optical signals to and from fluid probe 40, an FBG-based sensor cable 56 can extend throughout the structure of fluid probe 40 and include several FBG sensors 50. That is, FBG-based sensor cable 56 can be composed of a fiber optic cable with several FBG-sensors 50 spaced throughout the cable at various points, including branching terminal sections 58 of FBG-based sensor cable 56. At least one pressure port 60 can be located on the surface of fluid probe 40, which can lead to the interior of fluid probe 40.

An optical interrogator system 52 for sending and receiving optical signals can be coupled to FBG-based sensor cable 56 of fluid probe 40 through optical coupling 54. In addition, optical interrogator system 52 can include a broadband light source 70 in communication with optical coupling 54 to send optical signals to FBG-based sensor cable 56. Rejected (reflected or diffracted) optical signals can return to optical interrogator system 52 from FBG-based sensor cable 56 by traveling through optical coupling 54 in the opposite direction. Certain wavelengths of optical signals (e.g., “band reject” wavelengths) may diffract upon reaching FBG sensors 50. The wavelengths which diffract or reflect upon reaching one of the FBG sensors 50 can change based on the refractive index of each FBG sensor 50, which may in turn depend on a particular property of fluid probe 40. Specifically, a change in temperature or pressure within fluid probe 40 can alter the refractive index of FBG sensor 50 to change which wavelengths are rejected. Optical conversion software within optical interrogator system 52 can convert the diffracted optical signals into data in the form of an electronic signal, such as a digital signal.

To receive and/or record data, optical interrogator system 52 can be coupled to a computer system 80 through a data coupling 82, such as a wired connection, wireless connection, or any other currently known or later developed component for exchanging data between two systems or components. Computer system 80 can include any type of currently known or later developed computing device with a processing unit 84, and may include, e.g., a personal computer, a laptop, a tablet, a set-top box (STB), a Personal Digital Assistant (PDA), a mobile telephone or “smartphone” with computing functions, a web appliance, a network router, switch or bridge, a cloud-based computing device, or any machine capable of executing instructions (sequential or otherwise) that specify actions to be taken by that machine. Computer system 80 can include processing component 84 for receiving, interpreting, and performing mathematical functions. Processing unit 84 of computing device 80 can, e.g., mathematically derive physical properties of each FBG sensor 50 by using any currently known or later developed methods, algorithms, look-up tables, etc., for deriving physical data from data pertaining to diffracted optical signals. In addition, processing unit 84 of computer system 80 can determine and/or record baseline values for rejected optical signals from each FBG sensor 50 by manual or automatic calibration. Computer system 80 can include any currently known or alter developed apparatus, system, software product, etc., for deriving a material strain from a temperature and/or pressure, and/or for deriving a fluid condensation level from a temperature. Although computer system 80 is shown for the purposes of discussion as including one computing device, computer system 80 can include a group of computing devices, components, etc., if desired. In addition, computer system 80 can be located at a location that is physically remote from fluid probe 40 and/or optical interrogator system 52. In an example embodiment, optical interrogator system 52 can digitally encode optical signal data for transportation or transmission to a remote facility located several miles away from fluid probe 40.

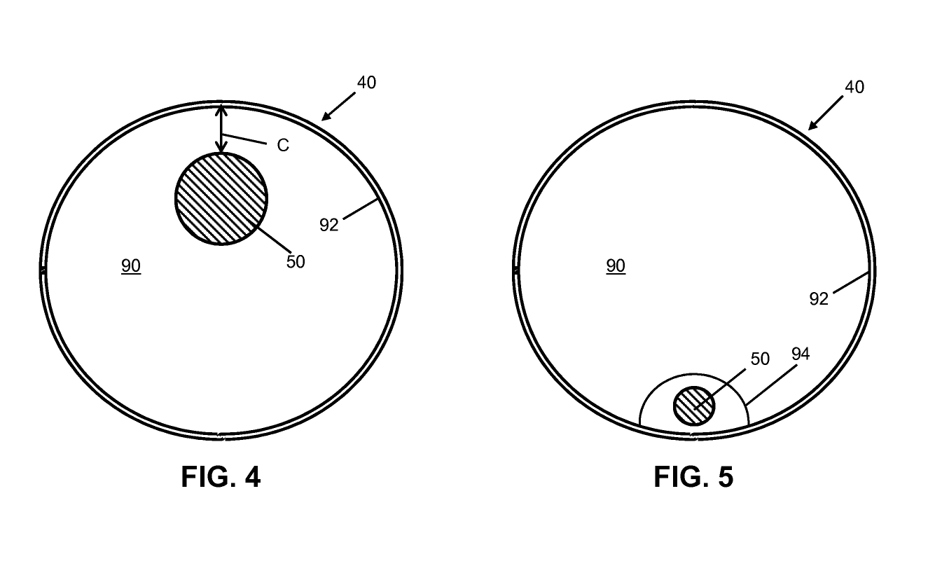

Turning to FIG. 4, an example embodiment of the present disclosure is shown. Fluid probe 40 can be a substantially hollow instrument for measuring fluid pressure, such as a tube-shaped structure (e.g., including tube 42 (FIG. 1)), with an interior cavity 90. Optionally, fluid probe 40 can include a kiel head pressure port 41 (FIG. 1) for orienting fluid probe 40 in a particular direction. FBG sensor 50 can be positioned within interior cavity 90 to monitor the condensation of operating fluid 32 (FIG. 1) within fluid probe 40. Gaseous operating fluid 32 (FIG. 1) within interior cavity 90 may condense into a liquid and contact FBG sensor 50 during the operation of a turbomachine. As condensed operating fluid 32 (FIG. 1) contacts FBG sensor 50, the temperature of FBG sensor 50 may change. The optical fibers used in FBG sensor 50 may expand or contract in response to temperature changes, thereby affecting the refractive index of FBG sensor 50. Thus, condensation of operating fluid 32 (FIG. 1) within fluid probe 40 can shift the optical signal wavelengths that FBG sensor 50 will reject. Optical interrogator system 52 (FIG. 3) can receive the rejected optical signals and convert the optical signals into digital signals for communication to computer system 80 via data coupling 82. Computer system 80 (e.g., through processing unit 84) can compare the diffracted wavelength values against baseline data to derive a temperature change and fluid condensation level within fluid probe 40. The baseline values for each comparison can be stored in computer system 80 and may be obtained via manual and/or automatic calibration. Where multiple FBG sensors 50 are positioned within one fluid probe 40, fluid condensation on a subset of FBG sensors 50 will indicate fluid condensation in a particular location on fluid probe 40.

In addition to fluid condensation, pressure changes (e.g., pressure from fluid probe 40 against FBG sensor 50), may compress or expand FBG sensor 50 to affect its refractive index. To reduce the effect of pressure changes, FBG sensor 50 can be suspended or “floating” within interior cavity 90, such that a clearance region C exists between FBG sensor 50 and a sidewall 92 of interior cavity 90. Coupling two ends of FBG-based sensor cable 62 (FIG. 3) to other structures of fluid probe 40 can allow at least one FBG sensor 50 to be suspended within interior cavity 90 without touching sidewall 92. Thus, the amount of fluid condensation within fluid probe 40 can be derived from the temperature change of FBG sensor 50 without other quantities, such as material strain, significantly affecting the refractive index of FBG sensor 50.

Turning to FIG. 5, another example apparatus according to an embodiment of the disclosure is shown. Fluid probe 40 can be substantially hollow, including interior cavity 90 positioned therein. Fluid probe 40 can optionally include a kiel-head port 41 (FIG. 1) to orient fluid probe 40 in a particular direction relative to the flow of operating fluid 32 (FIG. 1). FBG sensor 50 can be positioned within interior cavity 90 and can monitor the condition (e.g., material strain) of fluid probe 40 by measuring the pressure of fluid probe 40 against FBG sensor 50. In an embodiment, FBG sensor 50 can be coupled to sidewall 92 within interior cavity 90, such that FBG sensor 50 expands or contracts in response to pressure changes of sidewall 92 against FBG sensor 50. As the material strain of fluid probe 40 increases or decreases, FBG sensor 50 may expand or contract in response to the changing strain on sidewall 92.

In an example embodiment, an apparatus according to the present disclosure can include a flexible diaphragm 94 coupling FBG sensor 50 to sidewall 92 of fluid probe 40. Flexible diaphragm 94 may exert a predetermined amount of pressure against FBG sensor 50 and thereby define a baseline refractive index of FBG sensor 50. As the material properties (e.g., stress or strain) of fluid probe 40 change in response to environmental conditions, flexible diaphragm 94 may expand or contract, causing the pressure against FBG sensor 50 to change. The refractive index of FBG sensor 50 may change as fluid probe 40 and/or sidewall 92 experience strain or other material changes affecting the pressure of flexible diaphragm 94.

Changes in pressure, displacement, etc., of fluid probe 40 can affect the refractive index of FBG sensor 50, thereby shifting the wavelengths that FBG sensor 50 will reject. Optical interrogator system 52 (FIG. 3) can convert the received optical signal into a digital signal for communication to computer system 80 through data coupling 82. Computer system 80 (e.g., through processing unit 84), can compare the wavelength data against baseline values to drive a pressure change and material property, including localized strain, of fluid probe 40. The baseline values for comparison can be stored in computer system 80 and may be obtained via manual and/or automatic calibration. Where multiple FBG sensors 50 are included in one fluid probe 40, condensation on a subset of FBG sensors 50 can indicate material properties a particular location or region on fluid probe 40. Although the apparatuses for determining material properties and fluid condensation on fluid probe 40 are described separately, it is understood that apparatuses according to the present disclosure can also be used together to collect data for multiple properties simultaneously. In addition, the embodiments discussed herein can be applied to determine other variables capable of being measured with FBG sensor 50.

The various embodiments discussed herein can offer several technical and commercial advantages, some of which are discussed herein by way of example. Fluid condensation, pressure, or strain conditions of a fluid probe can be monitored with FBG sensors positioned within the structure of the fluid probe, e.g., within an interior cavity of the fluid probe. Thus, the material conditions of the fluid probe can be measured without affecting the exterior contour of the fluid probe, and therefore maintain the measuring quality of the fluid probe with minimal impact on turbomachine efficiency. In addition, employing FBG sensors with fluid probes as described herein can reduce the frequency and cost of positive air purges, a process for removing condensed fluids from a fluid probe. Specifically, the time for performing positive air purges can be determined with fluid condensation levels indicated by FBG sensors, instead of predetermined time intervals which may or may not correspond to the actual fluid condensation level within a fluid probe.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An apparatus comprising:
a fluid probe configured to be positioned within a fluid flow section of a turbomachine; and
a Fiber Bragg Grating (FBG) sensor coupled to the fluid probe and configured to indicate a material property at a particular location on the fluid probe.

2. The apparatus of claim 1, further comprising an optical interrogator system coupled to the FBG sensor and configured to send and receive an optical signal, wherein the FBG sensor is further configured to indicate the material property by diffracting a wavelength of the optical signal.

3. The apparatus of claim 1, wherein the FBG sensor is positioned within an interior cavity of the fluid probe.

4. The apparatus of claim 1, wherein the material property at the particular location on the fluid probe includes one of a fluid condensation level within an interior cavity of the fluid probe, and a material strain on the fluid probe.

5. The apparatus of claim 1, wherein the turbomachine includes a steam turbine, and the fluid probe is positioned within a low pressure section of the steam turbine.

6. The apparatus of claim 1, wherein the FBG sensor comprises part of an FBG-based sensor cable.

7. The apparatus of claim 1, wherein the FBG sensor includes a plurality of FBG sensors positioned throughout the fluid probe.

8. An apparatus comprising:
a fluid probe configured to be positioned within a fluid flow section of a turbomachine; and
a Fiber Bragg Grating (FBG) sensor positioned within an interior cavity of the fluid probe such that a clearance region exists between the FBG sensor and a sidewall of the interior cavity, wherein the FBG sensor is configured to indicate a fluid condensation level within the interior cavity of the fluid probe.

9. The apparatus of claim 8, wherein a temperature change of the FBG sensor indicates the fluid condensation level.

10. The apparatus of claim 8, further comprising an optical interrogator system coupled to the FBG sensor and configured to send and receive an optical signal, wherein the optical interrogator system is further configured to derive the fluid condensation level from a shift in refractive index caused by thermal expansion of the FBG sensor into the clearance region.

11. The apparatus of claim 8, wherein the fluid probe includes a kiel head pressure port.

12. The apparatus of claim 8, wherein the FBG sensor includes a plurality of FBG sensors positioned throughout the fluid probe.

13. The apparatus of claim 8, wherein the FBG sensor is further configured to indicate the fluid condensation level at a particular location on the fluid probe.

14. An apparatus comprising:
a fluid probe configured to be positioned within a fluid flow section of a turbomachine; and
a Fiber Bragg Grating (FBG) sensor coupled to a sidewall of an interior cavity of the fluid probe, wherein the FBG sensor is configured to indicate a material strain on the fluid probe.

15. The apparatus of claim 14, further comprising a flexible diaphragm coupling the FBG sensor to the sidewall of the interior cavity.

16. The apparatus of claim 15, wherein a pressure of the flexible diaphragm against the FBG sensor indicates the material strain on the fluid probe.

17. The apparatus of claim 14, further comprising an optical interrogator system coupled to the FBG sensor and configured to send and receive an optical signal, wherein the FBG sensor is further configured to indicate the material strain by diffracting a wavelength of the optical signal.

18. The apparatus of claim 14, wherein the fluid probe includes a kiel head pressure port.

19. The apparatus of claim 14, wherein the FBG sensor includes a plurality of FBG sensors positioned throughout the fluid probe.

20. The apparatus of claim 14, wherein the FBG sensor is further configured to indicate the material strain at a particular location on the fluid probe.
